(19) United States
(12) Patent Application Publication
(10) Pub. No.: US 2026/0073413 A1
(43) Pub. Date: Mar. 12, 2026

(54) METHOD AND APPARATUS FOR PREDICTING GAME REVENUE USING REVENUE FORECASTING MODEL

(71) Applicant: Kakao Games Corp., Seongnam-si (KR)

(72) Inventors: Daesub Song, Suwon-si (KR); Yoonyoung Cho, Yongsan-gu (KR)

(73) Assignee: Kakao Games Corp., Seongnam-si (KR)

(21) Appl. No.: 19/325,464

(22) Filed: Sep. 10, 2025

(30) Foreign Application Priority Data
Sep. 11, 2024 (KR) 10-2024-0124001

(51) Int. Cl. G06Q 30/0202; G06N 20/00

(52) U.S. Cl. CPC G06Q 30/0202; G06N 20/00

(57) ABSTRACT

A method for predicting game revenue using an artificial intelligence-based forecasting model, includes receiving, for a first game, rank information for each preset period on an application platform and past revenue information for each preset period preceding a first target period. A first input dataset is created by processing the rank information up to the first target period and the past revenue information preceding the first target period. A first predicted revenue amount for the first target period of the game is generated by inputting the first input dataset into a pre-trained revenue forecasting model. A second input dataset is then created by processing the first input dataset, rank information for a second target period subsequent to the first target period, and the first predicted revenue amount. A second predicted revenue amount for the second target period is generated by inputting the second input dataset into the revenue forecasting model.

### CROSS-REFERENCE TO RELATED APPLICATIONS

This application claims priority to and the benefit of Korean Patent Application No. 10-2024-0124001 filed in the Korean Intellectual Property Office on Sep. 11, 2024, the entire contents of which are incorporated herein by reference.

### TECHNICAL FIELD

The present disclosure relates to a revenue prediction technology, and in particular, to a method and an apparatus for predicting game revenue using a revenue forecasting model.

### BACKGROUND ART

Due to the rapid development of a mobile market, a huge amount of applications available in a mobile environment are being released. A service company that provides an application can charge a certain amount of money when installing an application on an individual user device and/or when using a specific service in the application on an application platform (Apple's App Store, Google's Google Play, etc.). Through this, the service company can obtain revenue through application provision, and can provide a higher-quality application through the revenue.

In the mobile market, a revenue rank is an index that has a most direct influence on a specific app and a company that services the app. In most industries, the exact amount of the company's revenue cannot be known until the end of the quarterly settlement. However, in a mobile industry, the application platform discloses the revenue rank in real time, so it is possible to infer the revenue rank. However, this is only the revenue rank, and it is the same as in other industries that the exact revenue of the company within the period are not known.

### SUMMARY OF THE INVENTION

The present disclosure is contrived in response to the above-described background art, and has been made in an effort to predict game revenue using a revenue forecasting model. For example, the present disclosure has been made in an effort to obtain a predicted revenue amount of a game by inputting rank information and revenue information of the game for each present period into the revenue forecasting model.

Meanwhile, a technical object to be achieved by the present disclosure is not limited to the above-mentioned technical object, and various technical objects can be included within the scope which is obvious to those skilled in the art from contents to be described below.

According to one aspect of the present disclosure for achieving the above-described object, a method for predicting game revenue using a revenue forecasting model, performed by a computing device is disclosed. The method may comprise: receiving, for a first game, rank information for each preset period on an application platform and past revenue information for each preset period preceding a first target period; creating a first input data, by processing the rank information for each preset period up to the first target period and the past revenue information for each preset period preceding the first target period, for the first game; generating a first predicted revenue amount for the first target period of the first game by inputting the created first input data into a pre-trained artificial intelligence-based revenue forecasting model; creating a second input data, by processing the first input data, the rank information for a second target period which is subsequent to the first target period, and the generated first predicted revenue amount, for the first game; and generating a second predicted revenue amount for the second target period of the first game by inputting the created second input data into the revenue forecasting model.

In one embodiment, the revenue forecasting model may be trained by: creating a training dataset by transforming rank information for each preset period on the application platform and past revenue information for each preset period, for each of a plurality of games, into training data comprising a pair of the rank information and the past revenue information for each preset period.

In one embodiment, the creating the first input data may comprise: applying, for the first game, an inverse operation into a rank for a first period and applying, for the first game, an inverse operation into a rank for a second period preceding the first period; comparing the inversed rank for the first period and the inversed rank for the second period to generate a difference value between the inversed ranks for the first period and the second period; and creating the first input data by configuring difference values between inversed ranks for each preset period up to the first target period of the first game, which are generated by the applying and the comparing.

In one embodiment, the creating the second input data may comprise: creating the second input data by configuring a difference value between an inversed rank for the first target period and an inversed rank for the second target period of the first game, which is generated by the applying and the comparing.

In one embodiment, the creating the first input data may comprise: transforming, using a trigonometric function, a temporal point within each preset period up to the first target period, into a transformation value including a sine value and a cosine value; and creating the first input data including the transformation value so that the transformation value is utilized for weight of the revenue forecasting model.

In one embodiment, the preset period may includes a plurality of period types including an hour, a day, a week, or a month, and a scope of the temporal point is varied depending on a period type.

In one embodiment, the creating the second input data may comprise: transforming, using the trigonometric function, the temporal point within each preset period up to the second target period, into the transformation value including the sine value and the cosine value; and creating the second input data including the transformation value so that the transformation value is utilized for weight of the revenue forecasting model.

In one embodiment, the method may further comprise: creating a third input data, by processing the second input data, the rank information for a third target period which is subsequent to the second target period, and the second predicted revenue amount, for the first game; and generating a third predicted revenue amount for the third target period by inputting the third input data into the revenue forecasting model.

In one embodiment, the method may further comprise, prior to generating the first predicted revenue amount: generating predicted revenue amount for each preset period preceding the first target period, by sequentially inputting the rank information and the past revenue information for each preset period preceding the first target period of the first game into the revenue forecasting model; identifying at least one anomaly period in which a difference value between actual revenue amount and predicted revenue amount exceeds a threshold difference value, by comparing the actual revenue amount included in the past revenue information with the predicted revenue amount for each preset period up to the first target period, for the first game;

and replacing the actual revenue amount for the at least one anomaly period with the corresponding predicted revenue amount.

In one embodiment, the method may further comprise: for a first anomaly period among the at least one anomaly period, in which the actual revenue amount is less than the predicted revenue amount, receiving information on at least one other game released within a pre-determined period before the first anomaly period; generating a competitor game list of the first game including the information on the at least one other released game; and storing the competitor game list mapped to the first game.

In one embodiment, the method may further comprise: for a second anomaly period among the at least one anomaly period, in which the actual revenue amount is greater than the predicted revenue amount, receiving user information regarding new users who joined the first game during the second anomaly period and event information related to revenue of the first game during the second anomaly period; calculating at least one of an average age or an average income of the new users based on the user information; and storing at least one of the average age or the average income mapped with the event information related to the first game.

In one embodiment, the event information may include information on external events that occurred outside the first game and information on in-game events that were conducted within the first game.

According to one aspect of the present disclosure, a computing device for predicting game revenue using a revenue forecasting model is disclosed. The computing device comprises: a processor including at least one core; a memory; and a network module, wherein the processor may be configured to: receive, for a first game, rank information for each preset period on an application platform and past revenue information for each preset period preceding a first target period; create a first input data, by processing the rank information for each preset period up to the first target period and the past revenue information for each preset period preceding the first target period, for the first game; generate a first predicted revenue amount for the first target period of the first game by inputting the created first input data into a pre-trained artificial intelligence-based revenue forecasting model; create a second input data, by processing the first input data, the rank information for a second target period which is subsequent to the first target period, and the generated first predicted revenue amount, for the first game; and generate a second predicted revenue amount for a second target period of the first game by inputting the created second input data into the revenue forecasting model.

According to one aspect of the present disclosure, a non-transitory computer readable storage medium including a computer program is disclosed. The computer program may cause a processor of a computer device to perform a method for predicting game revenue using a revenue forecasting model, the method comprising: receiving, for a first game, rank information for each preset period on an application platform and past revenue information for each preset period preceding a first target period; creating a first input data, by processing the rank information for each preset period up to the first target period and the past revenue information for each preset period preceding the first target period, for the first game; generating a first predicted revenue amount for the first target period of the first game by inputting the created first input data into a pre-trained artificial intelligence-based revenue forecasting model; creating a second input data, by processing the first input data, the rank information for a second target period which is subsequent to the first target period, and the generated first predicted revenue amount, for the first game; and generating a second predicted revenue amount for the second target period of the first game by inputting the created second input data into the revenue forecasting model.

According to some embodiments of the present disclosure, it is possible to predict game revenue using a revenue forecasting model.

Effects which can be acquired in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following embodiments, for purposes of explanation, numerous specific details are set forth to provide a comprehensive understanding of one or more aspects. However, it will be apparent that the aspect(s) can be executed without the specific detailed matters. In other examples, known structures and apparatuses are illustrated in a block diagram form in order to facilitate description of the one or more aspects.

FIG. 1 is a block diagram of a computing device which predicts game revenue using a revenue forecasting model according to one embodiment of the present disclosure.

FIG. 2 is a schematic diagram illustrating a network function according to one embodiment of the present disclosure.

FIG. 3 is a flowchart illustrating a method for predicting, by a computing device, game revenue using a revenue forecasting model according to one embodiment of the present disclosure.

FIG. 4 is an exemplary diagram illustrating a process of obtaining a predicted revenue amount by repeatedly driving a revenue forecasting model according to one embodiment of the present disclosure.

FIG. 5 is a flowchart illustrating a method for calculating a trigonometric function value related to a period input into a revenue forecasting model according to one embodiment of the present disclosure.

FIG. 6 is a simple and normal schematic diagram of an exemplary computing environment in which the embodiments of the present disclosure may be implemented.

### DETAILED DESCRIPTION

Various exemplary embodiments will now be described with reference to drawings. In this specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a procedure executed on a processor, the processor, an object, an execution thread, a program, and/or a computer, but is not limited thereto. For example, both an application executed in a computing device and the computing device may be the components. One or more components may reside within the processor and/or an execution thread. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

In addition, the term “or” is intended to mean not exclusive “or” but implicit “or”. That is, when not separately specified or not clear in terms of a context, a sentence “X uses A or B” is intended to mean one of the natural inclusive replacements. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

Further, it should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

In addition, the term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, constitutions, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other exemplary embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, terms represented by N-th such as first, second, or third are used for distinguishing at least one entity. For example, entities expressed as first and second may be the same as each other or different from each other.

A game in the present disclosure has been used for a purpose of illustration for convenience of description, and may be interpreted to encompass another category of application. Therefore, a person skilled in the art may also interpret a methodology of predicting a revenue amount of the game in the present disclosure as a methodology of predicting a revenue amount of an application. Hereinafter, embodiments of the present disclosure will be described using the term game for the purpose of the illustration.

A revenue forecasting model in the present disclosure may correspond to a pre-trained artificial intelligence model that outputs a predicted revenue amount of a specific game for a first target period by inputting rank information for each preset period and past revenue information for each preset period on an application platform of the specific game. That is, the revenue forecasting model may determine a trend of revenue according to a rank by inputting time series data on the rank and the revenue of the game. Examples of the revenue forecasting model may include, but are not limited to, a linear regression, a logistic regression, a decision making tree, a random forest, a support vector machine (SVM), a recurrent neural network (RNN), a long short-term memory (LSTM), a gated recurrent unit (GRU), and the like that process the time series data, and may include an artificial intelligence-based model of any structure and/or algorithm capable of processing the time series data.

The application platform in the present disclosure may refer to a service environment in which an application such as a game may be distributed and installed on a mobile device and/or a web. Examples of the application platform may include Apple's App Store, Google's Google Play, and the like. In addition, the application platform may calculate a rank of applications for each category, and disclose rank information of the applications.

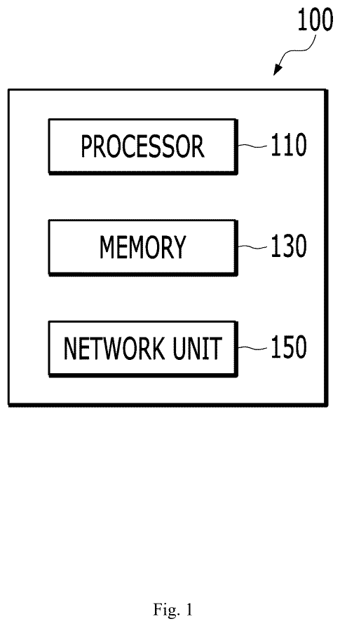

FIG. 1 is a block diagram of a computing device which predicts game revenue using a revenue forecasting model according to one embodiment of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

A computing device 100 according to some embodiments of the present disclosure may correspond to any form of server and/or any form of device that provides a plurality of games to users and manages the plurality of games and data related to users using each game. Further, the computing device 100 may be any form of server and/or any form of device for predicting game revenue using a revenue forecasting model. Examples of the computing device 100 may include any form of computer system or computer device such as a microprocessor, a main frame computer, a digital processor, a portable device, or a device controller.

The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for predicting the game revenue using the revenue forecasting model according to one embodiment of the present disclosure. That is, when the computer program stored in a computer-readable storage medium (for example, the memory 130) is executed by one or more processors (for example, the processor 110), the computer program may perform operations for predicting the game revenue using the revenue forecasting model according to one embodiment in the present disclosure. The processor 110 may implement any component for performing data processing for predicting the game revenue using the revenue forecasting model according to one embodiment of the present disclosure.

According to an exemplary embodiment of the present disclosure, the processor 110 may perform a calculation for training the neural network. The processor 110 may perform calculations for training the neural network, which include processing of input data for training in deep learning (DL), extracting a feature in the input data, calculating an error, updating a weight of the neural network using backpropagation, and the like. At least one of the CPU, GPGPU, and TPU of the processor 110 may process training of a network function. For example, both the CPU and the GPGPU may process the training of the network function and data classification using the network function. Further, in an exemplary embodiment of the present disclosure, processors of a plurality of computing devices may be used together to process the training of the network function and the data classification using the network function.

The processor 110 may generally control an overall operation of the computing device 100. The processor 110 may process a signal, data, information, and the like input or output through the components included in the computing device 100 or drive the application program stored in the memory 130 to provide or process information or a function appropriate for the user.

In one embodiment, the processor 110 may receive, for a first game, rank information for each preset period on an application platform and past revenue information for each preset period preceding a first target period. The processor 110 may input a first input data including the rank information for each preset period up to the first target period and the past revenue information for each preset period preceding the first target period, for the first game into a pre-trained artificial intelligence-based revenue forecasting model, and obtain a first predicted revenue amount for the first target period of the first game. The processor 110 may input, into the revenue forecasting model, a second input data including the first input data, and the rank information for a second target period which is subsequent to the first target period, and the first predicted revenue amount, for the first game, and obtain a second predicted revenue amount for the second target period of the first game.

In one embodiment of the present disclosure, the memory 130 may store any type of information generated or determined by the processor 110 and/or any type of information received by the network unit 150. For example, the memory 130 may store rank information for each preset period, past revenue information for each preset period, a predicted revenue amount for a specific period, a competitive game list, event information related to game revenue, and the like on an application platform for each of a plurality of games.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto. The memory 130 may be operated by the processor 110.

A network unit 150 according to an embodiment of the present disclosure may include any wired or wireless communication network capable of transmitting and receiving any form of data and signals, which can be referred to as a network in the present disclosure. The technologies described herein may be used in other networks as well as in the networks mentioned above.

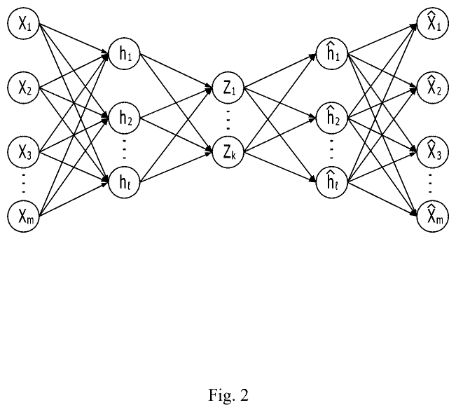

FIG. 2 is a schematic diagram illustrating a network function according to one embodiment of the present disclosure.

Throughout the present specification, an artificial intelligence-based model, a computation model, the neural network, a network function, and the neural network may be used as the same meaning.

The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, a definition of the layer is predetermined for description and the order of the layer in the neural network may be defined by a method different from the aforementioned method. For example, the layers of the nodes may be defined by the distance from a final output node. In one embodiment of the present disclosure, a set of neurons or nodes may be defined by the expression, layer.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes increases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes decreases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

The artificial intelligence-based model of the present disclosure may be represented by a network structure of any of the aforementioned structures, including an input layer, a hidden layer, and an output layer.

The neural network may be trained in at least one scheme of supervised learning, unsupervised learning, semi supervised learning, reinforcement learning, federated learning for distributed deep learning, or incremental learning. The learning of the neural network may be a process in which the neural network applies knowledge for performing a specific operation to the neural network.

The neural network may be trained in a direction to minimize errors of an output. The training of the neural network is a process of repeatedly inputting training data into the neural network and calculating the output of the neural network for the training data and the error of a target and back-propagating the errors of the neural network from the output layer of the neural network toward the input layer in a direction to reduce the errors to update the weight of each node of the neural network. In the case of the supervised learning, the training data labeled with a correct answer is used for each training data (i.e., the labeled training data) and in the case of the unsupervised learning, the correct answer may not be labeled in each training data. That is, for example, the training data in the case of the supervised learning related to the data classification may be data in which category is labeled in each training data. The labeled training data is input to the neural network, and the error may be calculated by comparing the output (category) of the neural network with the label of the training data.

As another example, in the case of the unsupervised learning related to the data classification, the training data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a training cycle (epoch). The learning rate may be applied differently according to the number of repetition times of the training cycle of the neural network. For example, in an initial stage of the training of the neural network, the neural network ensures a certain level of performance quickly by using a high learning rate, thereby increasing efficiency and uses a low learning rate in a latter stage of the training, thereby increasing accuracy.

In training of the neural network, the training data may be generally a subset of actual data (i.e., data to be processed using the trained neural network), and as a result, there may be a training cycle in which errors for the training data decrease, but the errors for the actual data increase. Overfitting is a phenomenon in which the errors for the actual data increase due to excessive training of the training data. For example, a phenomenon in which the neural network that trains a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the training data, regularization, dropout of omitting a part of the node of the network in the process of training, utilization of a batch normalization layer, etc., may be applied.

Disclosed is a computer readable medium storing the data structure according to an exemplary embodiment of the present disclosure. The aforementioned data structure may be stored in the memory 130 of the present disclosure, may be executed by the processor 110, and may be transmitted and received by the network unit 150.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection relationship between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device can perform operations while using the resources of the computing device to a minimum. Specifically, the computing device can increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

Throughout the present specification, a computation model, the neural network, a network function, and the neural network may be used as the same meaning. Hereinafter, the computation model, the neural network, the network function, and the neural network will be integrated and described as the neural network. The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for learning the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for learning the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called nodes. The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight is variable by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weight of the neural network may include a data structure including the weight which varies in the neural network learning process and/or the weight in which neural network learning is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

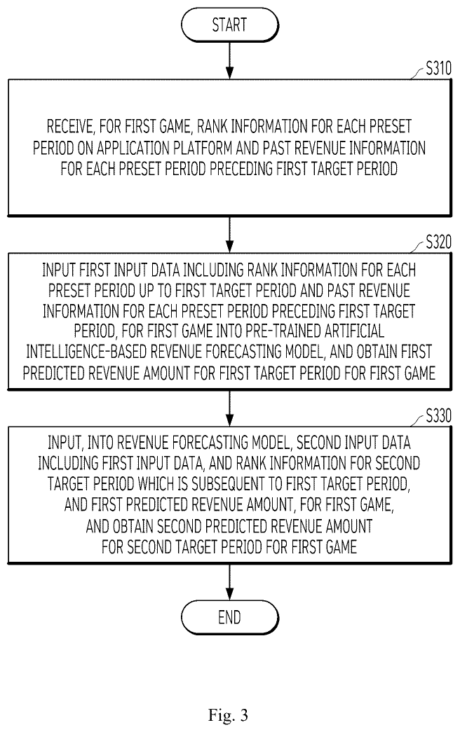

FIG. 3 is a flowchart illustrating a method for predicting, by a computing device, game revenue using a revenue forecasting model according to one embodiment of the present disclosure.

In step S310, the computing device 100 according to one embodiment may receive, for a first game, rank information for each preset period on an application platform and past revenue information for each preset period preceding a first target period. Hereinafter, a scheme in which the computing device 100 obtains a predicted revenue amount for the first game may be equally applied even to a plurality of respective games. The preset period may include a certain time-unit period, a certain day-unit period, a certain week-unit period, a certain month-unit period, a certain quarter-unit period, and the like. For example, the computing device 110 may receive the rank information and the past revenue information for the first game in real time and/or at a preset cycle.

In one embodiment, rank information of a game on the application platform may correspond to revenue rank information calculated based on revenue. Further, the rank information of the game may correspond to rank information for the game for each category. For example, the category for the game may include an RPG, an action, an adventure, a simulation, a sport, a puzzle, a strategy, and the like, according to a genre. As another example, the category of the game may include a PC, a mobile, a console, an online, a VR, and the like according to an execution device. The category of the game may include at least one subcategory for one upper category. The rank information may include rank information of games for each upper category and/or each subcategory.

In one embodiment, the past revenue information for the game may include actually calculated actual past revenue information and/or estimated past revenue information estimated by an external entity (a server, a device, etc.). The computing device 100 may receive past revenue information generated within a predetermined period and calculate the past revenue information for each preset period.

In one embodiment, the computing device 100 may create a first input data, by processing the rank information for each preset period up to the first target period and the past revenue information for each preset period preceding the first target period, for the first game. For example, the first input data may include the rank information for each preset period up to the first target period and the past revenue information for each preset period preceding the first target period, for the first game. As another example, the first input data may correspond to data preprocessed in a form in which raw data including the rank information for each preset period up to the first target period and the past revenue information for each preset period preceding the first target period, for the first game may be processed (or understood) by a pre-trained artificial intelligence-based revenue forecasting model.

In step S320, the computing device 100 according to one embodiment may input a first input data including the rank information for each preset period up to the first target period and the past revenue information for each preset period preceding the first target period, for the first game into a pre-trained artificial intelligence-based revenue forecasting model, and obtain a first predicted revenue amount for the first target period of the first game. For example, the computing device 100 may generate the first predicted revenue amount for the first target period of the first game by inputting the first input data into the revenue forecasting model. The first target period may correspond to one period of a plurality of periods classified as the preset period. The rank information for the first period of the first game may correspond to the past revenue information for the first period of the first game. In one embodiment, the target period may represent a reference period preset for revenue prediction.

For example, the computing device 100 may obtain rank information corresponding to each of the plurality of periods including the first target period of the first game, but may not obtain the past revenue information corresponding to the first target period of the first game. In this case, the revenue forecasting model may determine a trend, a seasonality, and/or a cycle of the revenue amount according to the rank of the first game by inputting time-series rank information up to the first target period and time-series past revenue information preceding the first target period, which corresponds thereto, and output a first predicted revenue amount of the first target period corresponding to the rank information for the first target period.

In one embodiment, the computing device 100 may set not only a calculation period of the rank information and the past revenue information, but also the number of pieces of rank information and past revenue information to be input into the revenue forecasting model. For example, the computing device 110 may obtain the first predicted revenue amount for the first target period by inputting preset numbers of rank information for each period and past revenue information for each period into the revenue forecasting model. For example, when the preset period is a daily-unit period, the computing device 120 may input rank information for seven days up to the first target period and past revenue information for six days preceding the first target period into the revenue forecasting model.

In one embodiment, the revenue forecasting model may correspond to an artificial intelligence model pre-trained using a training dataset including the rank information for each preset period and the past revenue information for each preset period on the application platform of each of the plurality of games. The computing device 100 may create the training dataset by transforming the rank information for each preset period and the past revenue information for each preset period on the application platform of each of the plurality of games. For example, the computing device 100 may create the training dataset by transforming raw data including the rank information for each preset period and the past revenue information for each preset period on the application platform of each of the plurality of games into a form which may be processed (or understood) by the revenue forecasting model. The revenue forecasting model may be trained based on the creation of the training dataset including the rank information for each preset period and the past revenue information for each preset period, on the application platform for each of the plurality of games. The training dataset may include a training data including a pair of the rank information and the past revenue information for each preset period. Further, the revenue forecasting model may correspond to an artificial intelligence model pre-trained by an eXtreme Gradient Boosting (XGBoost) algorithm scheme of updating a weight using a plurality of sub-models.

In one embodiment, a scale of a revenue amount for each revenue rank may be different depending on the category of the game. In this case, for more accurate revenue amount prediction, the revenue forecasting model may additionally receive the category of the game as well as the rank information and the past revenue information of the game. In this case, the training dataset may further include a category of each of the plurality of games. Further, a first input data and a second input data to be input into the revenue forecasting model may further include a category of the first game.

In one embodiment, the revenue forecasting model may be fine-tuned using a training dataset corresponding to each of the plurality of games. For example, the computing device 100 may fine-tune the revenue forecasting model for each game, and store the revenue forecasting model corresponding to each of the plurality of games.

In one embodiment, the revenue forecasting model may utilize not only the rank information but also any transformed form of rank information obtained from the rank information as a training data and/or an input data. For example, the training data and/or the input data of the revenue forecasting model may further include a difference value between inverses of both ranks as well as the rank information. The difference value between the inverses of the ranks may mean a difference value between an inverse of a rank of a first period and an inverse of a rank of a second period that is a period preceding the first period.

For example, when comparing a first rank variation in which the rank of the first game rises from 50th to 25th and a second rank variation in which the rank of the first game rises from 5th to 2nd, a difference value between the ranks of the first rank variation is 25, and a difference value between ranks of the second rank variation is 3. At this time, when the difference value between the ranks is simply input into the revenue forecasting model, a weight of the first rank variation will be set to be larger than a weight of the second rank variation. However, in an actual revenue amount variation, the second rank variance which is a variation between high ranks, is inevitably larger than the first rank variation which is a variation between low ranks. Therefore, in order to reflect this, a difference value between inverses of ranks may be added to the training data and/or the input data. For example, in the first rank variation, an inter-rank difference value is 1/25-1/50, i.e., 1/50, but in the second rank variation, the inter-rank difference value is 1/2-1/5, i.e., 3/10, and thus the weight of the second rank variation may be set to be larger than the weight of the first rank variation.

In one embodiment, the computing device 100 may calculate a difference value between the inverse of the rank for the first period of the first game and the inverse of the rank for the second period preceding the first period. For example, the computing device 100 may transform each rank information for each preset period into an inverse to generate transformed rank information for each preset period. The computing device 100 may calculate a difference value between transformed rank information with respect to consecutive periods. The computing device 100 may add the calculated difference value to the training data and/or the input data for the revenue forecasting model. For example, the first input data may further include a difference value between inverses of ranks for each preset period up to the first target period of the first game. As another example, the second input data may further include a difference value between an inverse of the rank for the second target period of the first game and an inverse of the rank for the first target period of the first game.

In one embodiment, the computing device 100 may apply an inverse operation into a rank for a first period of the first game. The computing device may apply an inverse operation into a rank for a second period that is a period preceding the first period. The computing device 100 may compare an inversed rank for the first period and an inversed rank for the second period to generate a difference value between the inversed ranks for the first period and the second period of the first game. The computing device 100 may compare the inversed rank for the first period and the inversed rank for the second period to generate the difference value between the inversed ranks for the second period and the first period of the first game. The computing device 100 may create the first input data by configuring difference values between inversed ranks for each preset period up to the first target period of the first game, which are generated based on the applying of the inverse operation and the comparing between the inversed ranks. Each of the first period and the second period may correspond to one preset period.

In one embodiment, the computing device 100 may create the second input data by configuring a difference value between the inversed rank for the first target period and the inversed rank for the second target period of the first game, which is generated based on the applying of the inverse operation and the comparing between the inversed ranks. The first period and the second period may correspond to the first target period and the second target period, respectively.

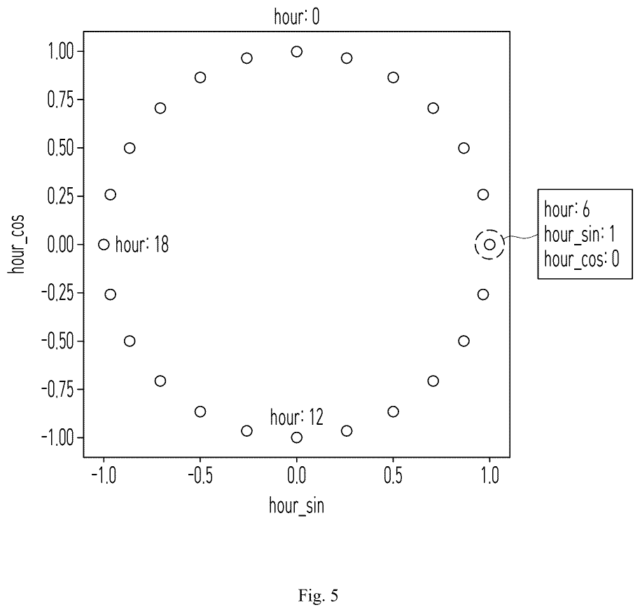

In one embodiment, the revenue forecasting model may utilize not only the rank information and the revenue information but also information on periods for which the rank information and the revenue information are calculated, as the training data and/or the input data. A detailed description of a methodology that utilizes the information on the periods as the training data and/or the input data will be described below with reference to FIG. 5.

In one embodiment, the computing device 100 may create a second input data, by processing the first input data, the rank information for a second target period which is subsequent to the first target period, and the first predicted revenue amount, for the first game. For example, the second input data may include the first input data, and the rank information for the second target period which is subsequent to the first target period, and the first predicted revenue amount, for the first game. As another example, the second input data may correspond to data preprocessed in a form in which raw data including the first input data, and the rank information for the second target period which is subsequent to the first target period, and the first predicted revenue amount, for the first game may be processed (or understood) by the pre-trained artificial intelligence-based revenue forecasting model.

In step S330, the computing device 100 according to one embodiment may input, into the revenue forecasting model, a second input data including the first input data, and the rank information for a second target period which is subsequent to the first target period, and the first predicted revenue amount, for the first game, and obtain a second predicted revenue amount for the second target period of the first game. For example, the computing device 100 may generate a second predicted revenue amount for the second target period of the first game by inputting the second input data into the revenue forecasting model. For example, the rank information for each preset period received by the computing device 100 may include the rank information for the first target period and the rank information for the second target period. The first predicted revenue amount may be included in the second input data as the past revenue information for the first target period corresponding to the rank information for the first target period. That is, the computing device 100 may interpolate missed past revenue information for the first target period by utilizing the first predicted revenue amount obtained from the revenue forecasting model as an input value of the revenue forecasting model again, and obtain the second predicted revenue amount for the second target period from the rank information of the second target period of the first game and the past revenue information up to the first target period.

In one embodiment, the computing device 100 may input, into the revenue forecasting model, a third input data including the second input data, and the rank information for a third target period which is subsequent to the second target period, and the second predicted revenue amount, for the first game, and obtain a third predicted revenue amount for the third target period of the first game. For example, the rank information for each preset period received by the computing device 100 may include the rank information for the first target period, the rank information for the second target period, and the rank information for the third target period. The second predicted revenue amount may be included in the third input data as the past revenue information for the second target period corresponding to the rank information for the second target period. That is, the computing device 100 may repeat a process of utilizing the predicted revenue amounts obtained from the revenue forecasting model as the input values of the revenue forecasting model again to interpolate missed past revenue information and obtain a predicted revenue amount for a desired period of the first game.

In one embodiment, the computing device 100 may create a third input data, by processing the second input data, and the rank information for the third target period which is subsequent to the second target period, and the second predicted revenue amount, for the first game. The computing device 100 may generate a third predicted revenue amount for the third target period of the first game by inputting the third input data into the revenue forecasting model. For example, the third input data may include the second input data, and the rank information for the third target period which is subsequent to the second target period, and the second predicted revenue amount, for the first game. As another example, the third input data may correspond to data preprocessed in a form in which raw data including the second input data, and the rank information for the third target period which is subsequent to the second target period, and the second predicted revenue amount, for the first game may be processed (or understood) by the revenue forecasting model.

In one embodiment, the computing device 100 may obtain a predicted revenue amount for each preset period preceding the first target period of the first game by sequentially inputting rank information and past revenue information for each preset period preceding the first target period of the first game into the revenue forecasting model, before obtaining the first predicted revenue amount. The computing device 100 may generate the predicted revenue amount for each preset period preceding the first target period of the first game by sequentially inputting the rank information and past revenue information for each preset period preceding the first target period of the first game into the revenue forecasting model, before generating the first predicted revenue amount. That is, the computing device 100 may obtain a predicted revenue amount corresponding to each rank information preceding the first target period by accumulating and inputting time-series rank information and past revenue information preceding the first target period into the revenue forecasting model.

In one embodiment, the computing device 100 may compare an actual revenue amount included in the past revenue information for each preset period preceding the first target period of the first game and the predicted revenue amount for each preset period preceding the first target period to identify at least one anomaly period in which a difference value between the actual revenue amount and the predicted revenue amount is equal to or larger than a reference difference value. That is, at least one anomaly period may correspond to a period in which the predicted revenue amount predicted through the revenue forecasting model is smaller or larger than the actual revenue amount by the reference difference value or larger.

In one embodiment, the computing device 100 may modify an actual revenue amount of past revenue information for each of at least one anomaly period into a predicted revenue amount corresponding to each of at least one anomaly period. That is, the computing device 100 may interpolate an actual revenue amount corresponding to an anomaly in the past revenue information into the predicted revenue amount obtained through the revenue forecasting model in order to more accurately obtain the predicted revenue amount for the first target period, the second target period, and/or the third target period through the revenue forecasting model.

In one embodiment, the computing device 100 may receive, with respect to a first anomaly period in which the actual revenue amount is smaller than the predicted revenue amount among at least one anomaly period, information on at least one release game different from the first game released within a predetermined period up to the first anomaly period. For example, when another game is released for the predetermined period up to the first anomaly, revenue of the first game may be reduced even in a case where a rank is not varied by a release of another game which is yet in a low rank. In this case, the computing device 100 may create a competitive game list for the first game including information on at least one release game. That is, the computing device 100 may determine at least one release game, which may vary the revenue of the first game, as a competitive game for the first game. The computing device 100 may map and store the competitive game list for the first game, and the first game. Accordingly, a game company may identify a competitive game that directly affects a revenue for each game, and achieve a technical effect of enabling monitoring of the competitive game.

In one embodiment, the computing device 100 may receive, with respect to a second anomaly period in which the actual revenue amount is larger than the predicted revenue amount among at least one anomaly period, information on new users who newly subscribe in the first game within the second anomaly period, and event information related to the revenue of the first game within the second anomaly period. For example, the revenue may rise even when the rank is not varied by an event related to the revenue related to the first game during the second anomaly period. The event information may include information on an external event which occurs outside the first game and information on an internal event which progresses within the first game. For example, the information on the external event of the first game may include advertisement information for the first game. The advertisement information may include information on an advertisement platform, an advertisement scheme, the number of advertisements, an advertisement image, an advertisement model, etc. The information on the internal event of the first game may include game vent information, item release information, etc., which is conducted within the second anomaly period in the first game.

In one embodiment, the computing device 100 may calculate, based on information on new users, at least one of an average age or an average income of the new users. The computing device 100 may map and store at least one of the average age or average income calculated and the event information related to the first game. Accordingly, it is possible to achieve a technical effect that a service company that provides the first game may envision an advertisement targeting a specific age and/or a specific income, based on the advertisement information of the first game mapped to the average age and/or average income of the new users. In addition, it is possible to achieve a technical effect that the service company may envision a game event and/or an item targeting a specific age, and/or a specific income, based on game event information and/or item release information of the first game mapped to the average age and/or average income of the new users.

Through the present disclosure, even when a plurality of past revenue information is missing, it is possible to achieve a technical effect that an accurate revenue amount may be predicted from time-series rank information and past revenue information by using the revenue forecasting model.

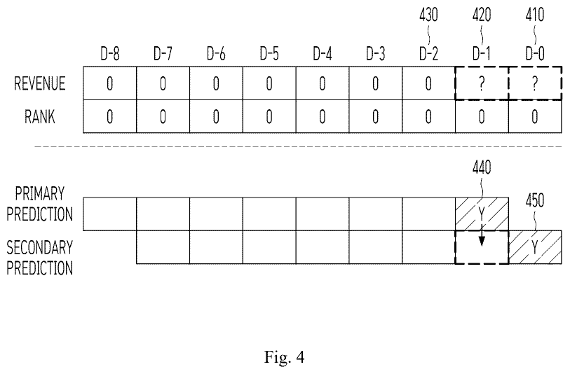

FIG. 4 is an exemplary diagram illustrating a process of obtaining a predicted revenue amount by repeatedly driving a revenue forecasting model according to one embodiment of the present disclosure.

Referring to FIG. 4, the rank information and the revenue amount may correspond to each other for each period. For example, first rank information and first revenue information for a first period 410 may correspond to each other, second rank information and second revenue information for a second period 420 may correspond to each other, and third rank information and third revenue information for a third period 430 may correspond to each other. At this time, revenue information of the first period 410 and the second period 420 may be missing. The computing device 100 may repeatedly drive the revenue forecasting model to finally predict the first revenue information for the first period 410.

For example, the computing device 100 may obtain a second predicted revenue amount 440 for the second period 420 by inputting a first input data including rank information for each preset period up to the second period 420 and revenue information for each preset period up to the third period 430 into the revenue forecasting model, as a primary prediction. The computing device 100 may obtain a first predicted revenue amount 450 for the first period 410 by inputting a second input data including the first input data, the rank information for the first period 410, and the second predicted revenue amount 440 into the revenue forecasting model as a secondary prediction. Meanwhile, when the number of rank information for each period and the number of past revenue information for each period to be input into the revenue forecasting model are preset, most past rank information and past revenue information in the first input data may be excluded from the second input data, at a secondary prediction step of obtaining the first predicted revenue amount 450.

FIG. 5 is an exemplary diagram illustrating a method for calculating a trigonometric function value related to a period input into a revenue forecasting model according to one embodiment of the present disclosure.

In one embodiment, the revenue forecasting model may utilize not only the rank information and the revenue information but also information on periods for which the rank information and the revenue information are calculated, as the training data and/or the input data. For example, since a trend for revenue may vary for each day, for each week, and for each month, the computing device 100 may additionally reflect information on a period to the revenue forecasting model to consider the trend for the period when predicting the revenue.

In one embodiment, the computing device 100 may calculate a sine value and a cosine value corresponding to a first period by using a trigonometric function. In this case, the sine value or the cosine value of the first period may include a sine value and a cosine value of at least one of a first time, a first day, a first week, or a first month corresponding to the first period. For example, the time, the day, the week, and/or the month corresponding to the first period may correspond to the time, the date, the week, or the month at a last temporal point of the first period.

For example, in an example in which a time corresponding to the first period is 23:00 and a time corresponding to a second period is 0:00, a time difference between the first period and the second period is 1 hour, but in respect to a weight of a time actually reflected to the revenue forecasting model, a weight of the first period may be set to be much greater than a weight of the second period. Therefore, the computing device 100 may set a more accurate weight by reflecting a temporal concept to the revenue forecasting model by using the trigonometric function.

For example, when a preset period for calculating the rank and the revenue is from 23:00 on a previous day to 23:00 on a same day, the rank information for each period may correspond to a rank from 23:00 on the previous day to 23:00 on the same day, and the past revenue information for each period may correspond to past revenue information from 23:00 on the previous t day to 23:00 on the same day. For example, when a first period for which the rank and revenue information are calculated is from 23:00 on August 28 to 23:00 on August 29, a first time corresponding to the first period may be 23:00, a first day may be a 29th day, and a first month may be August. The training data may include a sine value and a cosine value of at least one of a time, a day, a week, or a month corresponding to each period. Further, the first input data may further include a sine value and a cosine value for each preset period up to the first target period. Further, the second input data may further include a sine value and a cosine value for each preset period up to the second target period.

In one embodiment, the computing device 100 may transform, using the trigonometric function, a temporal point for each preset period up to the first target period, into a transformation value including the sine value and the cosine value, in creating the first input data. The computing device 100 may create the first input data including the transformation value so that the transformation value is utilized for a weight of the revenue forecasting model.

In one embodiment, the preset period may include a plurality of period types including an hour, a day, a week, or a month. For example, the preset period may correspond to a time unit cycle, a day unit cycle, a week unit cycle, or a month unit cycle. A scope of the temporal point may be varied depending on a period type.

In one embodiment, the computing device 100 may transform, using the trigonometric function, a temporal point for each preset period up to the second target period, into a transformation value including the sine value and the cosine value, in creating the second input data. The computing device 100 may create the second input data including the transformation value so that the transformation value is utilized for a weight of the revenue forecasting model.

For example, the sine value and the cosine value corresponding to the first period may be calculated by Equation 1 below.

$$\begin{matrix}sine value : sin ( \frac{2 π}{max ( x )} * x ) \\ cosine value : cos ( \frac{2 π}{max ( x )} * x )\end{matrix} \qquad [ Equation 1 ]$$

In Equation 1 above, x may refer to a time, a day, a week, or a month corresponding to a preset period. max (x) may be 24 when x is a time unit, 30 or 31 when x is a day unit, 4 or 5 when x is a week unit, and 12 when x is a month unit.

Referring to FIG. 5, a graph showing a sine value and a cosine value of a time corresponding to a preset period is shown. For example, a total of 24 temporal points from 0:00 to 23:00 may be represented on the graph. In this case, for example, when the preset period is from 6:00 on the previous day to 6:00 on the same day, the sine value or the cosine value for 6:00 may be calculated as shown in Equation 2 below.

$$\begin{matrix}sine value for 6 : 00 : sin ( \frac{2 π}{24} * 6 ) = 1 \\ cosine value for 6 : 00 : cos ( \frac{2 π}{24} * 6 ) = 0\end{matrix} \qquad [ Equation 2 ]$$

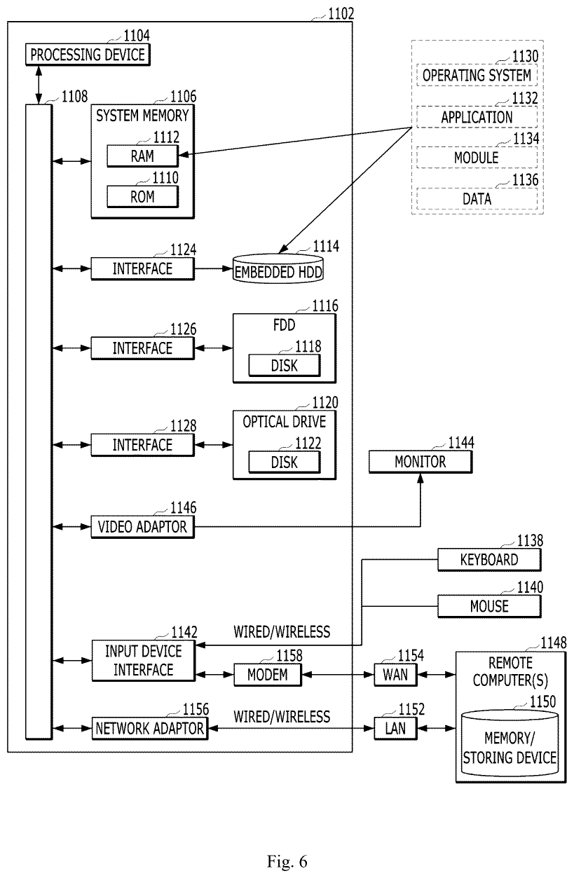

FIG. 6 is a simple and normal schematic diagram of an exemplary computing environment in which the embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal obtained by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

Referring to FIG. 6, An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a microprocessor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for predicting game revenue using a revenue forecasting model, performed by a computing device, comprising the steps of:
receiving, for a first game, rank information for each preset period on an application platform and past revenue information for each preset period preceding a first target period;
creating a first input data, by processing the rank information for each preset period up to the first target period and the past revenue information for each preset period preceding the first target period, for the first game;
generating a first predicted revenue amount for the first target period of the first game by inputting the created first input data into a pre-trained artificial intelligence-based revenue forecasting model;
creating a second input data, by processing the first input data, the rank information for a second target period which is subsequent to the first target period, and the generated first predicted revenue amount, for the first game; and
generating a second predicted revenue amount for the second target period of the first game by inputting the created second input data into the revenue forecasting model.

2. The method of claim 1, wherein the revenue forecasting model is trained by:
creating a training dataset by transforming rank information for each preset period on the application platform and past revenue information for each preset period, for each of a plurality of games, into training data comprising a pair of the rank information and the past revenue information for each preset period.

3. The method of claim 1, wherein the creating the first input data comprises:
applying, for the first game, an inverse operation into a rank for a first period and applying, for the first game, an inverse operation into a rank for a second period preceding the first period;
comparing the inversed rank for the first period and the inversed rank for the second period to generate a difference value between the inversed ranks for the first period and the second period; and
creating the first input data by configuring difference values between inversed ranks for each preset period up to the first target period of the first game, which are generated by the applying and the comparing.

4. The method of claim 3, wherein the creating the second input data comprises:
creating the second input data by configuring a difference value between an inversed rank for the first target period and an inversed rank for the second target period of the first game, which is generated by the applying and the comparing.

5. The method of claim 1, wherein the creating the first input data comprises:
transforming, using a trigonometric function, a temporal point within each preset period up to the first target period, into a transformation value including a sine value and a cosine value; and
creating the first input data including the transformation value so that the transformation value is utilized for weight of the revenue forecasting model.

6. The method of claim 5, wherein the preset period includes a plurality of period types including an hour, a day, a week, or a month, and a scope of the temporal point is varied depending on a period type.

7. The method of claim 5, wherein the creating the second input data comprises:
transforming, using the trigonometric function, the temporal point within each preset period up to the second target period, into the transformation value including the sine value and the cosine value; and
creating the second input data including the transformation value so that the transformation value is utilized for weight of the revenue forecasting model.

8. The method of claim 1, further comprising:
creating a third input data, by processing the second input data, the rank information for a third target period which is subsequent to the second target period, and the second predicted revenue amount, for the first game; and
generating a third predicted revenue amount for the third target period by inputting the third input data into the revenue forecasting model.

9. The method of claim 1, further comprising, prior to generating the first predicted revenue amount:
generating predicted revenue amount for each preset period preceding the first target period, by sequentially inputting the rank information and the past revenue information for each preset period preceding the first target period of the first game into the revenue forecasting model;
identifying at least one anomaly period in which a difference value between actual revenue amount and predicted revenue amount exceeds a threshold difference value, by comparing the actual revenue amount included in the past revenue information with the predicted revenue amount for each preset period up to the first target period, for the first game; and
replacing the actual revenue amount for the at least one anomaly period with the corresponding predicted revenue amount.

10. The method of claim 9, further comprising:
for a first anomaly period among the at least one anomaly period, in which the actual revenue amount is less than the predicted revenue amount, receiving information on at least one other game released within a pre-determined period before the first anomaly period;
generating a competitor game list of the first game including the information on the at least one other released game; and
storing the competitor game list mapped to the first game.

11. The method of claim 9, further comprising:
for a second anomaly period among the at least one anomaly period, in which the actual revenue amount is greater than the predicted revenue amount, receiving user information regarding new users who joined the first game during the second anomaly period and event information related to revenue of the first game during the second anomaly period;
calculating at least one of an average age or an average income of the new users based on the user information; and
storing at least one of the average age or the average income mapped with the event information related to the first game.

12. The method of claim 11,
wherein the event information includes information on external events that occurred outside the first game and information on in-game events that were conducted within the first game.

13. A computing device for predicting game revenue using a revenue forecasting model, comprising:
a processor including at least one core;
a memory; and
a network module,
wherein the processor is configured to:
receive, for a first game, rank information for each preset period on an application platform and past revenue information for each preset period preceding a first target period;
create a first input data, by processing the rank information for each preset period up to the first target period and the past revenue information for each preset period preceding the first target period, for the first game;
generate a first predicted revenue amount for the first target period of the first game by inputting the created first input data into a pre-trained artificial intelligence-based revenue forecasting model;
create a second input data, by processing the first input data, the rank information for a second target period which is subsequent to the first target period, and the generated first predicted revenue amount, for the first game; and
generate a second predicted revenue amount for a second target period of the first game by inputting the created second input data into the revenue forecasting model.

14. A non-transitory computer readable storage medium including a computer program, wherein the computer program causes a processor of a computer device to perform a method for predicting game revenue using a revenue forecasting model, the method comprising the steps of:
receiving, for a first game, rank information for each preset period on an application platform and past revenue information for each preset period preceding a first target period;
creating a first input data, by processing the rank information for each preset period up to the first target period and the past revenue information for each preset period preceding the first target period, for the first game;
generating a first predicted revenue amount for the first target period of the first game by inputting the created first input data into a pre-trained artificial intelligence-based revenue forecasting model;
creating a second input data, by processing the first input data, the rank information for a second target period which is subsequent to the first target period, and the generated first predicted revenue amount, for the first game; and
generating a second predicted revenue amount for the second target period of the first game by inputting the created second input data into the revenue forecasting model.
